(19) United States
(12) Patent Application Publication
(10) Pub. No.: US 2016/0325846 A1
(43) Pub. Date: Nov. 10, 2016

(54) GREENBOX: MOVING ALARM APPARATUS WITH GPS AND METHOD OF USE, DESIGNED FOR AIRCRAFT, SHIPS, TRAINS, BUSES AND OTHER FORMS OF TRANSPORTATION

(71) Applicant: James Lawrence Kearns, Jacksonville, FL (US)

(72) Inventor: James Lawrence Kearns, Jacksonville, FL (US)

(21) Appl. No.: 14/675,511

(22) Filed: Mar. 31, 2015

(51) Int. Cl. B64D 45/00

(52) U.S. Cl. CPC B64D 45/00

(57) ABSTRACT

The Greenbox: moving alarm apparatus with GPS designed for aircraft, ships, trains, busses and other forms of transportation is a remotely monitored alarm system which is designed to allow for alarm systems similar to regular home alarms, but designed for moving systems and to be remotely accessed with video and sound in real-time. It includes alarms designed specifically for the mode of transportation it is designed for. It maintains the data in recoverable form by providing for remote access as well as storage of the data, constantly uploaded to an Internet website during an alarm, as well as within a fireproof and waterproof safe. It will approve for use the GPS systems used in cars to be sanctioned for aircraft so that the location of commercial aircraft can be determined at all times, so that 911 will never happen again, and so that planes and ships will not be lost.

### CROSS-REFERENCES TO RELATED APPLICATIONS

Not Applicable. (Continuation of previously abandoned application Ser. No. 13/892,248, now revised with new matter added).

### FEDERALLY SPONSORED RESEARCH

Not Applicable.

### SEQUENCE LISTING OR PROGRAM

Not Applicable.

### BACKGROUND OF THE INVENTION

1. Field of the Invention

The present invention relates to an alarm system designed for moving aircraft, ships, trains, busses and other modes of transportation, and more specifically that allows remote access and control in moving systems and storage of data, and to allow for remotely monitored status alarms (as listed in the claims) (1) for altitude, (2) GPS location indicator, (3) proximity to other aircraft, (4) icing condition monitoring, (5) landing gear status, (6) passenger cabin pressure alarm/noise alarm/disturbance alarm, (7) attitude alarm, (8) speed/stall alarm, (9) low fuel alarm, (10) fire alarms from the cabins and engines, (11) and power loss alarm. (12) Remote access options to include arm/disarm and (13) lock/unlock of the flight cabin doors will be added as necessary. Further it provides highjack prevention and virtual security personnel aboard the moving aircraft. Other status alarms will be added later, as required. It will continuously upload real-time video and sound to a web site for access at a later time, or in real-time as much as possible, and allow for monitoring conditions aboard the aircraft or other modes of transportation, show GPS location, and warnings of crash or life threatening conditions aboard the aircraft. If a loss of bandwidth is evident, than upload of video and sound will be only during the times when an alarm is being sent.

2. Description of the Related Art

In the current technology, some systems have remotely monitored systems that now do show video and sound from moving cars that are used primarily by law enforcement. It is not known by me who may hold a patent, if one exists, on this system. They are not in wide use today, not approved for aircraft, and generally not in use for ships, trains, and busses. The remotely monitored systems are not set up as “alarm” systems which will send an alarm when threating conditions exist, and do not show altitude and proximity to other aircraft, ships, submarines, etc., monitor icing conditions, show status of landing gear, etc., as previously stated, depending on the mode of transportation it is implemented on, or upload the data for temporary storage. The data is also not retrievable after a crash from the system, as well as from the uploaded area, and saved in a fireproof and waterproof “safe” device for retrieval after the crash, sinking or even explosion.

Current systems in use for static locations such as one such system patented by Hsu, Tau-Jeng (Taipei, TW), U.S. Pat. No. 8,421,624, is an improved method of security and allows for upload to the internet, but this is from a stationary location, is for home security and not moving aircraft, ships, submarines, or the designed for the security of moving systems. All heretofore known security type alarm systems are for stationary systems and not moving transport systems, which include remote access and security monitoring from static non-moving locations.

Current systems in use aboard aircraft (Black Box) are not remotely monitored, just record sound, monitor the cockpit radio messages and other data, and are not remotely accessed. They do not show any video and must be retrieved after the fact of a crash to be of any use. They do not broadcast back the GPS location, send alarms to a remote location, or preform any of the primary functions of this proposed systems. Currently, aircraft and ships have been lost essentially forever, as in the case of Malaysia Airlines flight 370, which as of the date of this application has never been found. This is a huge expense for the airlines and government, due to the billions spent on trying to find lost aircraft and ships. Had this type system have been in place at the time of 911, perhaps it could have been prevented.

Based on the foregoing, there is a need in the art for a remotely accessible system which will show video and broadcast sound from the in-flight aircraft, broadcast back the GPS location, send alarms to a monitoring area when threatening conditions exist, show proximity to other aircraft and ships and other modes of transportation, to the ground monitoring location that is not being broadcast as a radar signal, but over the Internet and stored on a data file that can be remotely accessed. Radar systems are not always able to show the location of the aircraft, ship, or submarine, or other mode of travel. This is evident as a myriad of aircraft and ships have been lost forever, even in very recent times. Costs to the military and authorities to search for the lost aircraft or ships is unknowable.

### BRIEF SUMMARY OF THE INVENTION

This invention relates to a newly developed alarm system for moving systems and not for static un-moving systems. As stated previously the system will send an alarm from moving aircraft, ships, submarines, trains, busses and other modes of transportation to a monitoring station that is ground-based. Since 911, airline security has strived to make aircraft secure by concentrating all efforts on access being restricted from persons and things that should not be loaded on the plane, but once the plane is loaded and takes off, there is no security system. The Captain, crew and stewardesses are the only security and are not always able to monitor what may be happening inside the cabin, or even outside the plane. This system will allow the passenger cabin to be monitored real-time from a remote location, both with video and sound, as well as the flight cabin, and to send alarms to the ground-based monitoring station when conditions warrant these alarms.

1. It will monitor the altitude and if it is not at a safe altitude that it should be maintaining, an alarm will be sent. The alarm will also sound in the cockpit. Ground-based personnel would then attempt to contact the aircraft or other crew, via Internet communication modes to advise them of the alarm and then the authorities by phone.

2. An alarm will be sent for proximity to other aircraft when within a two mile radius while at altitude. The alarm will also sound in the cockpit, but will also be sent to the ground monitoring station. The monitoring station will attempt to notify the aircraft crew first via Internet communications and then the authorities by phone.

3. An alarm will be sent for landing gear not down when attempting landing or down during flight when it should be up. The alarm will also sound in the cockpit, but will also be sent to the ground monitoring station. The monitoring station will attempt to notify the aircraft crew first via Internet communications and then the authorities by phone.

4. An alarm will be sent when icing conditions exist and ice is building up on the wings. The alarm will not only sound in the cockpit, but also be sent to the ground monitoring station. The monitoring station will attempt to notify the aircraft crew first via Internet communications and then the authorities by phone.

5. An alarm will be sent when there is a cabin condition such as loud noises, disturbances, loss of cabin pressure, or unusual activity detected. The alarm will not only sound in the cockpit, but also be sent to the ground monitoring station. The monitoring station will attempt to notify the aircraft or other crew first via Internet communications and then the authorities by phone.

6. An alarm will be sent when there is an unusual attitude of the aircraft or ship, such as pointing nearly completely strait down, gaining or losing altitude too quickly, or too great right or left pitch, when in danger of sinking or capsizing. The alarm will not only sound in the cockpit or bridge, but also be sent to the ground monitoring station. The monitoring station will attempt to notify the aircraft or other crew first via Internet communications and then the authorities by phone.

7. An alarm will be sent to the monitoring station and also to the cabin when there is unusual slow or fast speed for the aircraft. The alarm will not only sound in the cockpit, but also be sent to the ground monitoring station. The monitoring station will attempt to notify the aircraft crew first via Internet communications and then the authorities by phone.

8. An alarm will be sent to the monitoring station and also to the aircraft flight cabin or ship's bridge when there is a low fuel condition. The monitoring station will attempt to notify the aircraft or other crew first via Internet communications and then the authorities by phone.

9. An alarm will be sent to the monitoring station and also to the aircraft flight cabin or ship's bridge, or other control area when there is a fire and/or smoke condition. The monitoring station will attempt to notify the aircraft or other crew first via Internet communications and then the authorities by phone.

10. In ship, and/or submarine applications a flood alarm will also sound as well as for aircraft. The monitoring station will attempt to notify the aircraft or other crew first via Internet communications and then the authorities by phone.

11. An alarm will be sent if the aircraft or ship loses power in an engine. The monitoring station will attempt to notify the aircraft or other crew first via Internet communications, and then the authorities by phone.

There is currently no system like this or in use by aircraft manufacturers or general aviation or with ships, trains or busses. This would be a redundant and autonomous system to the currently used Black Box. It will allow for security personnel to have an in-flight or at-sea view of the cabin and flight cabin and ship's bridge as though they were actually on board the aircraft, ship or other mode of transportation. Unlike the systems in use today, this system will allow for remote access just as with static systems, the same with the moving systems, which is remotely monitored, as well as viewable by the flight crew, aboard moving systems, and this is the patentable novel idea.

The advantages of the present invention are (1) alarms of variable types (as previously stated) being sent from moving aircraft to a remote location while the aircraft is in operation; (2) real-time video and sound remotely accessible by ground based personnel; (3) upload of data to the Internet for access at a later time; (4) virtual additional passengers, security personnel, and crew aboard the aircraft and remote monitoring from a ground-based location; (5) increased security aboard aircraft, ships, submarines, trains, busses or other modes of transportation while the transportation mode is moving; (6) identical access with moving and static systems for alarm monitoring; (7) contact back from the remote monitoring station to notify the aircraft crew via internet communications, and notification of authorities of alarms; and (8) GPS positioning indications of the transportation mode.

This system would provide that recordings of video and sound would be uploaded utilizing existing Internet portals and then once uploaded onboard the aircraft, the instantaneous access by ground security personnel is granted. Currently systems use either cell or satellite transmission portals to permit airline Internet access.

The only systems currently in use by commercial aircraft and ships are the Black Box System, which does not allow for real-time access, but only after the fact. Systems that are aboard specific aircraft, such as Air Force One, are also not known to have this capability, but would be monitored by in-flight security and not ground personnel. Radio voice transmission is then broadcast, but not video and sound in the manner proposed here. It is not set up as an alarm type system. Two-way video and sound communications in real-time is established by website upload by this system which is not currently in use at this time.

In the event that Internet transmission is not available, the system would still record for future upload, as soon as the Internet transmission becomes available, so no loss of visual or sound would be lost, providing it has power to the system. To provide the highest resolution in a dark condition, black and white cameras would be used, with possible night vision capabilities employed by the system.

A possible restriction of the system is that transmission may be lost, due to the failure of the Internet connection where satellite or cell transmission is not available. This will be overcome by constant recording by the system and storage to the DVD Recorder for upload as the system becomes available. Further, unless an incident is occurring, it may not be necessary to save all the data and monitor all activity, but only necessary incidents. The data would be deleted if not needed within a prescribed period of time, usually after 90 days.

This system is patentable because it is adapting alarm type systems and methods, which previously apply only to static systems and adapting them to moving systems, and requires specific development of technologies to provide for this monitoring and alarms aboard moving systems that previously heretofore are only available on static systems. The novel idea is adapting static alarm system technology to moving systems. One cannot just take a standard alarm system and place it in a moving system and have a viable working system. Simple video and sound being broadcast from a moving system is not adapted as an alarm system, with the alarm technologies in the current patented technologies.

### BRIEF DESCRIPTION OF THE SEVERAL VIEWS OF THE DRAWINGS

FIG. 1 is a top plain view of cockpit and typical cameras, alarms, and microphones placement and open view of Greenbox: a moving alarm apparatus with GPS designed for aircraft, ships, trains, busses, and other forms of transportation, according to an embodiment of the present invention.

FIG. 2 is a top plain view of the passenger cabin and typical camera, microphone, and alarm placements for Greenbox: a moving alarm apparatus with GPS designed for aircraft, ships, trains, busses, and other forms of transportation, according to an embodiment of the present invention.

FIG. 3 is a depiction of technology development to enable remote monitoring of video, sound, and alarms, from Greenbox: a moving alarm apparatus with GPS designed for aircraft, ships, trains, busses, and other forms of transportation, according to an embodiment of the present invention.

FIG. 4 is a conceptual perspective view showing the ship mode for installation of Greenbox: a moving alarm apparatus with GPS designed for aircraft, ships, trains, busses, and other forms of transportation, according to an embodiment of the present invention.

### DETAILED DESCRIPTION OF THE PREFERRED EMBODIMENT

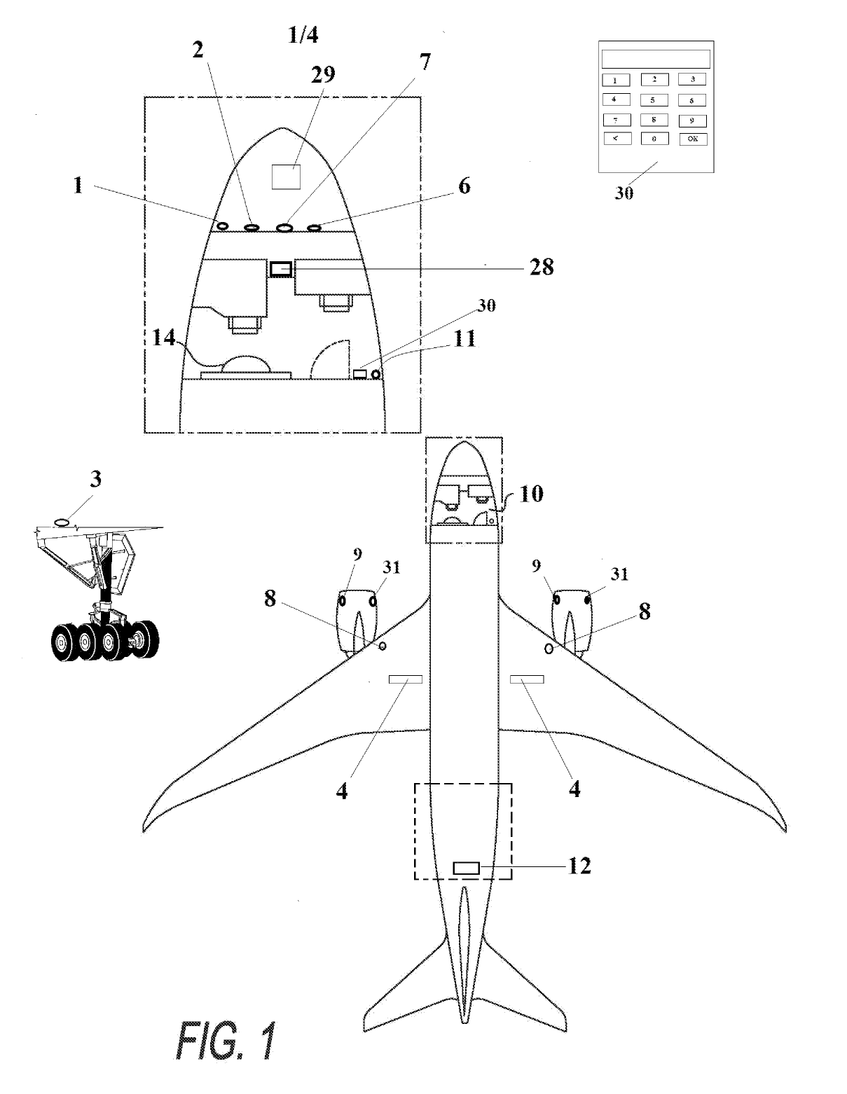

Preferred embodiments of the present invention and their advantages may be understood by referring to FIGS. 1-4, wherein like reference numerals refer to like elements.

Following is a listing of reference numerals of FIGS. 1-4.

Item 1 in FIG. 1 is an altitude alarm conceptual drawing of the alarm placement in the cockpit;

Item 2 in FIG. 1 is a conceptual drawing showing the proximity alarm placement configuration in the airplane cockpit;

Item 3 in FIG. 1 is showing a conceptual drawing of the landing gear alarm in an airplane landing gear area which will sound when gear is not down during landing or remaining down during flight;

Item 4 in FIG. 1 is representing the proposed conceptual location of remotely monitored icing alarms which will sound if ice builds up on the aircraft wing during flight;

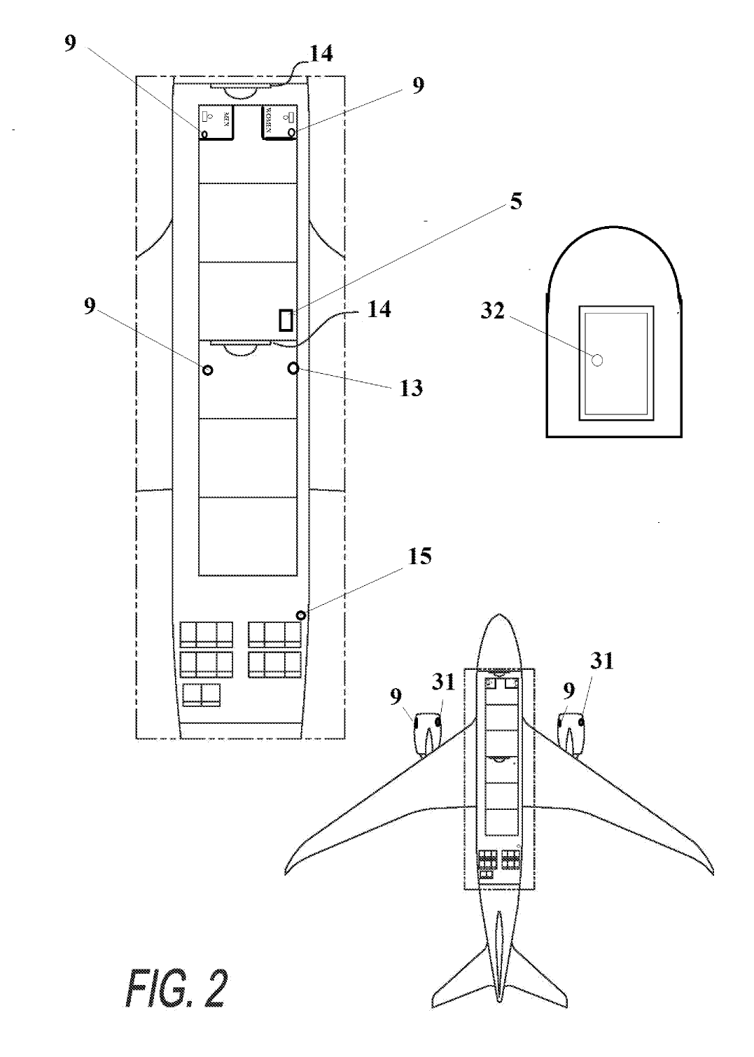

Item 5 in FIG. 2 is a conceptual drawing of the cabin alarm which will sound if loud noises, cabin pressure loss, or disruptions occur;

Item 6 in FIG. 1 is an attitude alarm placement that will sound anytime the aircraft is at an unusual attitude, such as pointing nearly straight down or at to great an angle from the ground level during normal flight operations;

Item 7 in FIG. 1 is the airspeed alarm which will sound anytime the aircraft is below stall speed or above the maximum speed for the aircraft, according to the manufacturer;

Item 8 in FIG. 1 is representing the low fuel alarms, which will sound anytime the fuel level is below the level set by the manufacturer as safe for sustained flight;

Items 9 in FIGS. 1 & 2 are representing the remotely monitored fire alarms and placement areas for the cabin and the engines;

Item 10 in FIG. 1 is representing the pilot cabin in an aircraft;

Item 11 in FIG. 1 is a depiction of the variable microphone types and placements in the flight cabin of the aircraft;

Item 12 in FIG. 1 is the proposed location of the waterproof and fireproof “safe” enclosing the DVR and data storage systems, which is aft of all cabin areas;

Item 13 in FIG. 2 is representing the proposed variable microphones and types used for placement in the aircraft cabin;

Items 14 in FIGS. 1 & 2 are the proposed camera placement in the aircraft passenger and flight cabins of the aircraft;

Item 15 in FIG. 2 is the proposed placement of the flood alarm in in the aircraft passenger cabin which will sound when the aircraft becomes fully or partially submerged;

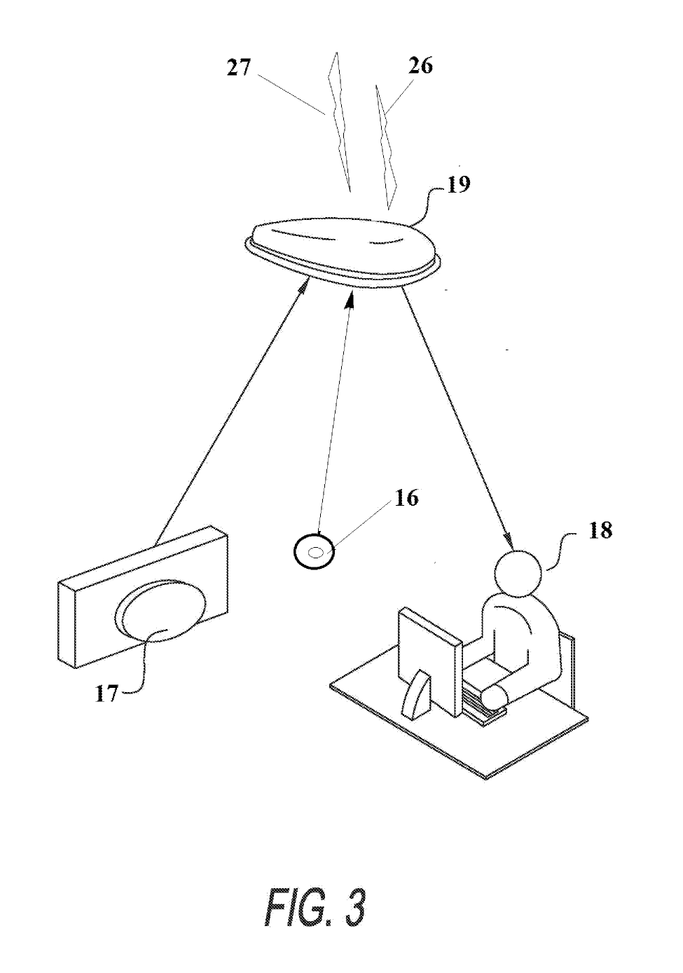

Item 16 in FIG. 3 is a depiction of the microphone(s) and other alarm types and kinds and the fact that they will broadcast a remotely monitored real-time sound file or alarm signal to the monitoring station;

Item 17 in FIG. 3 is a depiction of the camera(s) and the fact that they will send a remotely viewable real-time video file to the monitoring station;

Item 18 in FIG. 3 is a depiction of a person setting at a monitoring computer, monitoring alarms at the monitoring station;

Item 19 in FIG. 3 is a representation of the antenna system required for operation to receive and send signals from the satellite or cell tower;

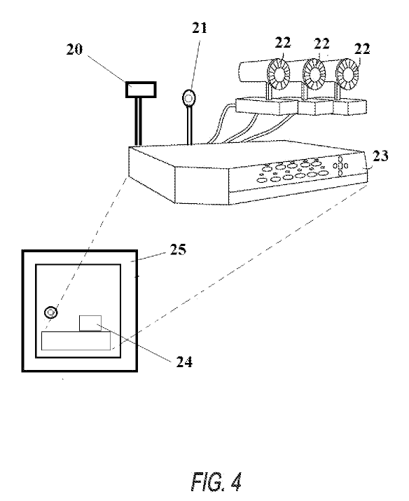

Item 20 in FIG. 4 is a depiction of the flood alarm for a ship mode alarm system;

Item 21 in FIG. 4 is a depiction of the microphone(s) and other types and kinds of alarms in the ship mode alarm system type;

Items 22 in FIG. 4 are representative of the multiple cameras in the ship mode configuration;

Item 23 in FIG. 4 is representative of the DVR recorder that will be placed inside the fireproof and waterproof safe in the ship alarm configuration;

Item 24 in FIG. 4 is representative of the fireproof and waterproof data storage device utilized in the ship alarm configuration;

Item 25 in FIG. 4 is representative of the safe used for further fireproof, waterproof, and collision protection of the data in a ship alarm configuration;

Item 26 in FIG. 3 is representing the signals sent to the satellite or cell tower from the antenna in the aircraft alarm configuration mode;

Item 27 is representing received signals by the antenna from the cell tower or satellite in the aircraft alarm configuration mode;

Item 28 in FIG. 1 is representing the monitoring screen for the flight crew aboard the aircraft;

Item 29 in FIG. 1 is representing the GPS location device that will send a signal to the monitoring station as to the location and altitude of the aircraft;

Item 30 in FIG. 1 is the program, arm or disarm Security Alarm Keypad; and

Item 31 in Figure is representing power loss alarms which will send alarms to the cabin and to the monitoring station.

With reference to FIGS. 1-4, Item 1 represents the altitude alarm in the aircraft configuration mode and sounds when the aircraft is below 1000 feet from ground level, and is broadcast to the remote monitoring station. Under normal circumstances the alarm may sound, but only in the cockpit and not to the remote monitoring station. As further depicted in the drawing, Item 2 in FIG. 1 is representative a remotely monitored proximity alarm to other aircraft while flying. It will sound both in the cockpit when within 2000 feet in any direction of another aircraft. Under normal circumstances, it will sound only in the cockpit, but in this case it will also send an alarm to the remote monitoring station. As further depicted in the drawing, Item 3 is representative of the alarm which will indicate if the landing gear is not down for landing or continues to be down during normal flight operations. Under normal circumstances, it will sound only in the cockpit, be recorded in the Black Box, but in this case it will also send an alarm to the remote monitoring station. As further depicted in the drawing, Items 4 are the icing alarms which will sound when ice is forming on the wings of the aircraft and an alarm will sound both in the cockpit and also be sent to the monitoring station. To my knowledge, no such alarms currently exist for aircraft at this time.

Item 5 in FIG. 2 is representative of a cabin alarm when loud noises such as a gunshot, glass breakage, cabin pressure loss, or disturbances in the cabin are evident. No such alarm exists at this time designed for aircraft, which are remotely monitored from a ground station, and this is the patentable idea. Under normal circumstances, a cabin pressure loss signal only would be sent to the flight cabin, but in this case, it will also send an alarm to the remote monitoring station. As further depicted in the drawing, Item 6 is an attitude alarm which will sound when the aircraft is at an attitude that will sound when the aircraft, submarine or ship configured alarm reach an angle of greater than 50° down angle either right or left or down. For acrobatic type aircraft, this alarm would be disabled or removed. Under normal circumstances, if currently being utilized in all modes, it will sound only in the cockpit, be recorded by the Black Box, but in this case it will also send an alarm to the remote monitoring station. As further depicted in the drawing, Item 7 in FIG. 1 is representing a speed/stall/exceeding airspeed alarm. It will sound when the speed is less than or greater than speeds assigned by the manufacturer. Under normal circumstances, if currently being utilized in all modes, it will sound only in the cockpit, but in this case it will also send an alarm to the remote monitoring station. As further depicted in the drawing, Items 8 in FIG. 1 are low fuel alarms. It will send an alarm to the flight cabin and the remote monitoring station when fuel is below the safe level set by the manufacturer for safe continued flight. Under normal circumstances, if currently being utilized in all modes, it will sound only in the cockpit, be recorded in the black box, but in this case it will also send an alarm to the remote monitoring station.

Items 9 in FIG. 2 are the fire alarms. They will send an alarm to the flight cabin in the event of fire or smoke detection in the aircraft cabin, restrooms, or plane engines. Under normal circumstances, if currently being utilized in all modes, they will sound only in the cockpit, be recorded in the Black Box, and in the general area of placement, but in this case they will also send an alarm to the remote monitoring station. As further depicted in FIG. 1, Item 10 is a depiction of the small view of the aircraft flight cabin. Not all alarms are shown due to size in this diagram. As further depicted in the drawing, Item 11 in FIG. 1 is representing the microphone that is sending the sounds from the cockpit during flight to the recorder. This microphone will also capture the sounds from the radio and the control tower for recording by the DVR, while it is in communication to the aircraft. This will not be an alarm, but will be able to be monitored by the remote monitoring station in real-time. As further depicted in the drawing, Item 12 in FIG. 1 is the location of the waterproof and fireproof “safe” which will include the contents of the DVR, the I/O Data Storage Device, which is also fireproof and protects data for ½ hour from data loss in a fire for up to 1550° Fahrenheit and waterproof to protect data from loss in up to 10 feet of water for up to 72 hours. The “safe” configuration in which the data storage device is stored will further protect the data from loss by further providing fireproof and waterproof assurance. In addition, the fact that it is being broadcast continually to the monitoring station, data loss should be kept to an absolute minimum and viable at 90% data recovery. As further depicted in the drawing, Item 13 in FIG. 2 is the passenger cabin microphone, that will pick up the sound in the cabin so that a sound “file” which is in real-time can be sent to the monitoring station and will pick up the sounds and send to the recorder, the primary sounds from the passenger cabin. This will not be an alarm but will be collected data for the alarm system monitoring station to store until it is determined it can be deleted after no incidents aboard the aircraft in 90 days. As further depicted in the drawings, Items 14, in FIGS. 1 and 2 are representing multiple camera placements in the flight cabin and passenger cabins. These may include clandestine cameras, or visible cameras. These are not alarms but will send images to the DVR recorder to be broadcast to the monitoring station in real-time for storage until it is determined the images can be deleted after no incidents aboard the aircraft after 90 days. As further depicted in the drawing, Item 15 in FIG. 2 is a flood alarm that will sound in the event water submerges the alarm. Under normal circumstances, if currently being utilized in all modes, it will sound only in the cockpit or bridge and the Black Box, depending on the application, but in this case it will also send an alarm to the remote monitoring station.

Item 16 in FIG. 3 is representing various alarm types as described in the previous text, and demonstrating that these alarms are designed to send signals to the monitoring station. Under normal circumstances, if currently being utilized in all modes, it will sound only in the cockpit, bridge or to the conductor or driver of the bus, but in this case it will also send an alarm to the remote monitoring station. The current technology only would be applied to static systems and not moving systems as in this patent application. As further depicted in the drawings, Item 17 in FIG. 3 represents the various types and kinds of camera systems that will send digital video to the monitoring station. Under normal circumstances, if currently being utilized in all modes, it will only send video signals to the black box, cockpit, bridge, conductor, or driver of the bus, but without the application of an active alarm system. In this case, however, it will also send an alarm to the remote monitoring station for storage until it is determined it can be deleted after 90 days with no alarm incidents being sent. As further depicted in the drawing, Item 18 in FIG. 3 is representative of the Security Officer, Military Personnel, or Monitoring Agent, who will have the ability to answer alarms and contact the aircraft or other transportation mode with the signal that is being displayed and also have the ability to contact the authorities if necessary. They will also be able to view real-time images and hear real-time sounds from the aircraft or other transportation mode. They will also be able to determine the GPS position, altitude, and proximity of the aircraft(s) to other aircraft, or other transportation mode they are monitoring. They will help to relive the pressure from control towers which are understaffed and will provide a secondary monitoring station that does not rely solely on radar, but in this case Internet communications.

The antenna is shown as Item 19 in FIG. 3 is representative of a common antenna type, and will send and receive signals from the alarm system in the aircraft and from the monitoring station as well as from the satellite or cell tower. This system has been around for many years, but is used primarily for Internet communications and not alarm purposes as depicted in this present invention. It currently has limited capabilities to show video and sound programs from television programs broadcast over the Internet and phone communications, while connecting with cell towers and Internet broadcasts, while in communication with satellites, but in this application it will be for an alarm system aboard a moving system, which previously was only from a static location. As further depicted in the drawing, Item 20 in FIG. 4 is representing a plethora of alarms and types from the system in a ship configuration mode. It will include the flood, fire, proximity to other ships, fuel, and attitude, to indicate sinking or capsizing, and any other alarms needed. Under normal circumstances, if currently being utilized in all modes, these alarms will sound only in the bridge and the Black Box, and the location of the alarm, but in this case it will also send an alarm to the remote monitoring station. As further depicted in the drawing, Item 21 in FIG. 4 is representing the microphone(s) that will collect sound from the area in which they are installed, and be able to be recorded by the DVR for broadcast and listened to in real-time at the monitoring station. This is not an alarm but collected data to be sent to the monitoring station until it is determined it can be deleted in 90 days after no alarm incidents. As further depicted in the drawings, Items 22 in FIG. 4 are representing the plethora of camera types that will image digital video for broadcast to the recording area of the DVR to be sent to the monitoring station. Under normal circumstances, if currently being utilized in all modes, they will send images only to the bridge and the Black Box, but in this case they will also send digital images to the remote monitoring station. As further depicted in the drawing, Item 23 is the DVR Recorder that will record for broadcast the images and sound in real-time and send the data to the monitoring station so that it can be viewed and listened to in real-time. Under normal circumstances, if currently being utilized in all modes, it will send the images to the bridge and black box, but in this case it will also send alarms to the remote monitoring station from a moving location. The DVR Recorder has the capability now to send signals over Internet communications from a static location, but not in an alarm mode in relation to aircraft and other moving systems, and not from a moving system, as data being sent over non-static Internet communications will result in a loss of signal in currently utilized modes.

Item 24 as depicted in FIG. 4 is the previously described I/O Data Storage System. As previously stated it has the capability to protect data for ½ hour from data loss in a fire for up to 1550° Fahrenheit, and waterproof to protect data from loss in up to 10 feet of water for up to 72 hours. As further depicted in the drawing, Item 25 in FIG. 4 is the protective safe as applied in the application aboard a ship mode. It will further protect from data loss up to the limitations of the safe system. In general, safe systems will protect for up to 1700° Fahrenheit and for up to 24 hours in 8 inches of water. The combined system protections of the I/O Safe as well as the protection of the standard safe with modifications will insure data loss prevention of 90% when used in conjunction with remote broadcast of the signals in the ship mode. In the aircraft mode, the lighter fireproof and waterproof box will generally be limited to the I/O Data Storage Device limitations, but with remote broadcast the data loss prevention should still be the 90%. As further depicted in FIG. 3, Item 26 is representative of the signals being sent to the satellite or cell tower. As further depicted in FIG. 3 Item 27 is representative of signals received from the satellite or cell tower. As further depicted in FIG. 1, Item 28 is representing the monitor which the pilot and co-pilot will be able to view the passenger cabin and other video from the cameras, as well as view if any alarms are being sent. As further depicted in the drawing, Item 29 in FIG. 1 is representative of the GPS location indicator. While this system is commonly used in vehicles now, it is currently not approved for aircraft and not widely in use in ships, and not in conjunction with a remotely monitored alarm system which is the current invention. As further depicted in the drawing Item 30 in FIG. 1 is a diagram of the arm or disarm box which also shows the recommended location of the device. It will set or disarm, program, and is similar to the normal Security Alarm Keypad for a static alarm, but will control the remotely monitored alarms aboard a moving aircraft, ship or other transportation mode. Finally, Items 31 in FIGS. 1 & 2 is the power loss alarm which will sound and send an alarm to the flight cabin and also to the monitoring station whenever there is a loss of power from any engine, jet or other propeller.

What is claimed is:

1. Greenbox: a moving alarm apparatus with GPS designed for aircraft, ships, trains, busses, and other forms of transportation comprising:
a. software designed for remote access of security alarms on moving systems;
b. a functioning alarm system that will alarm in moving systems to a ground-based monitoring station, utilizing Internet communications;
c. video in real-time being broadcast in conjunction with the alarm system on moving systems through Internet communications, viewable by the crew and ground-based personnel;
d. sound files that are broadcast in real-time from moving systems in conjunction with an alarm system through Internet communications that will be able to be listened to by the ground-based monitoring station security personnel;
e. a remotely monitored altitude alarm that is broadcast in real-time from an aircraft that will sound and send an alarm to the ground-based monitoring station when the aircraft is 1000 feet from ground level;
f. the ability to arm or disarm the system and program from the cockpit, bridge, or control area of the transportation mode and will be able to be monitored from the ground-based monitoring station by utilizing an alarm keypad;
g. a remotely monitored proximity alarm from moving systems that will sound and send an alarm to the ground based monitoring station when the aircraft, ship, submarine or helicopter, or other form of transportation is within 2000 feet in any direction of another aircraft, ship, submarine, or helicopter (does not apply to trains or busses, or other ground-based transportation modes);
h. a remotely monitored status alarm for aircraft landing gear, that will sound in the flight cabin and send an alarm to a ground-based monitoring station when the landing gear is not down in preparation for landing or remaining down during flight;
i. a remotely monitored icing alarm for aircraft that will sound in the flight cabin and send an alarm to the ground-based monitoring station when icing conditions cause a build-up of ice on the wings;
j. a remotely monitored passenger cabin alarm that will send an alarm to the ground-based monitoring station and the cockpit of the aircraft when there is a loud noise in the passenger cabin, or loss of cabin pressure, or disturbance;
k. a remotely monitored attitude alarm that will sound in the aircraft cabin and also send an alarm to the ground-based monitoring station when the aircraft is at an unusual attitude of 50° down or right or left angle;
l. a remotely monitored speed alarm that will sound in the cockpit and also send an alarm to a ground-based monitoring station when the aircraft is below stall speed set by the manufacturer or above the maximum speed for the aircraft;
m. a remotely monitored fuel alarm that will sound in the aircraft cockpit and also send an alarm to the ground-based monitoring station when the fuel is below safe levels for continued flight set by the manufacturer;
n. a remotely monitored fire and/or smoke alarm that will send a signal to the bridge, flight cabin or control center of the mode of transportation and also to the monitoring station when there is a threat of fire; and
o. a remotely monitored flood alarm that will send a signal to the bridge, flight cabin or control center of the mode of transportation and also to the monitoring station when there is a threat of flooding.

2. Greenbox: moving alarm apparatus with GPS designed for aircraft, ships, trains, busses and other forms of transportation of claim 1, further comprising the enclosure of the DVR and I/O Data Storage Device within a protective safe to protect from fire and/or flood.

3. Greenbox: moving alarm apparatus with GPS designed for aircraft, ships, trains, busses and other forms of transportation of claim 1, further comprising adaptation for ships, trains, busses, submarines, helicopters, and other forms of transportation, even down to individual cars.

4. Greenbox: moving alarm apparatus with GPS designed for aircraft, ships, trains, busses and other forms of transportation of claim 1, further comprising the GPS (Global Positioning System) in conjunction with the alarm system to send warnings and alarms to the cockpit and also to the monitoring station when there is a threat of being off course, or to low in altitude.

5. Greenbox: moving alarm apparatus with GPS designed for aircraft, ships, trains, busses and other forms of transportation of claim 1, further comprising a method of recovery of data from the system, both through monitoring of data from the monitoring station and by physical recovery of the devices equal to at least 90% of the data being recoverable.

6. Greenbox: moving alarm apparatus with GPS designed for aircraft, ships, trains, busses and other forms of transportation of claim 1, further comprising the following remotely accessible and/or alarm components:
a. the DVR (Digital Video Recorder) to store data from the video and sound recordings and to also permit the remote access to the data from the ground-based monitoring station;
b. variable cameras to capture the images in digital form for remote viewing of what is happening aboard a moving aircraft or other form of transportation in real-time and providing virtual security aboard the mode of travel;
c. variable microphone types which will capture the sounds and allow the sounds to be recorded and broadcast to the monitoring station for real-time access to the sounds in conjunction with the video;
d. an altitude alarm;
e. GPS location indicator;
f. a proximity alarm;
g. landing gear status alarm;
h. icing alarm;
i. passenger cabin pressure, noise, disturbance alarm;
j. attitude alarm;
k. speed/stall alarm;
l. low fuel alarm;
m. fire alarms;
n. power loss alarms;
o. arm/disarm of the keypad; and
p. lock/unlock of the flight cabin/bridge doors.

7. Greenbox: moving alarm apparatus with GPS designed for aircraft, ships, trains, busses and other forms of transportation of claim 1, further comprising the following list of non-remotely accessible components and/or non-alarming devices:
a. the safe;
b. the data storage device; and
c. the antenna.
